(19) United States
(12) Patent Application Publication
(10) Pub. No.: US 2012/0070595 A1
(43) Pub. Date: Mar. 22, 2012

(54) Extensible Heat Transfer Labels Formed from Energy Curable Compositions

(76) Inventors: Jeffrey T. Sloat, Broomfield, CO (US); Mark Sinclair, Arvada, CO (US)

(21) Appl. No.: 13/238,320

(22) Filed: Sep. 21, 2011

Related U.S. Application Data
(60) Provisional application No. 61/385,271, filed on Sep. 22, 2010.

(51) Int. Cl. G09F 3/10; B32B 1/02; G09F 3/04; B05D 5/10; B32B 37/12; G09F 3/02; B32B 3/10; B32B 7/12

(52) U.S. Cl. 428/35.7; 428/195.1; 428/201; 427/207.1; 156/160

(57) ABSTRACT

A heat transfer label assembly includes a label portion including an energy cured ink and releasably supported on a carrier. At least a portion of the label portion is extensible at least about 5% in at least one direction without creating substantial defects in the label portion.

### CROSS-REFERENCE TO RELATED APPLICATION

This application claims the benefit of U.S. Provisional Application No. 61/385,271, filed Sep. 22, 2010, which is hereby incorporated by reference herein in its entirety.

### BACKGROUND

Curable (i.e., crosslinkable) ink and coating compositions or systems have been in widespread use for many years. Since curable compositions or systems are typically 100 wt % solids, curable systems are considered to be more environmentally acceptable than solvent-base systems, which release solvents into the atmosphere. Further, curable systems allow for more process flexibility, since the coating or printing machine can be stopped without concern about a solvent (water or organic) evaporating prematurely.

During the curing process, curable ink and coating systems form crosslinked materials (e.g., polymers or resins) known as thermosets. The cured inks and coatings are resistant to abrasion, chemicals, and heat, but typically have limited flexibility and extensibility. Accordingly, these generally non-extensible, cured inks and coatings have not found use in printing applications that may require substantial flexibility and/or extensibility, such as heat transfer labels. When heat transfer labels are applied to a container having a contoured shape, the heat transfer label must be able to conform to the shape of the container. If the heat transfer label lacks sufficient flexibility and extensibility, it may crack or break when it is joined to the shaped container.

Accordingly, there is a need for curable inks and/or coating compositions for use in forming flexible and extensible cured inks and coatings. There is also a need for a sufficiently flexible and extensible heat transfer label formed from one or more curable compositions.

### SUMMARY

In one aspect, this disclosure is directed generally to at least partially curable inks and/or coating compositions that form flexible, extensible inks and/or coatings, and the inks and/or coatings formed therefrom. The ink and/or coating compositions may generally include at least one thermosetting (i.e., curable) material and, optionally, a viscosity modifier. In some examples, the viscosity modifier may comprise a monomer, a thermoplastic resin, or any combination thereof. The ink and/or coating compositions may be cured in any suitable manner, for example, using ultraviolet (UV) light or electron beam radiation (EB).

In another aspect, this disclosure is directed generally to a flexible and extensible heat transfer label. At least a portion of the heat transfer label may generally be capable of being stretched or elongated at least about 5% in at least one direction (so that its dimension increases in at least the one direction) without creating substantial defects in the label (e.g., without substantially cracking, speckling, or distorting) when the label is applied to a container. In some examples, at least a portion the heat transfer label may stretch from about 6% to about 20%, for example, from about 8% to about 15%, for example, about 10% in at least one direction without forming substantial defects in the label. The heat transfer label may be formed from one or more curable ink and/or coating compositions, for example, energy curable ink and/or coating compositions.

In still another aspect, this disclosure is directed generally to a heat transfer label assembly including a flexible and extensible heat transfer label or label portion. The heat transfer label assembly may include a carrier on which the heat transfer label is supported. Additionally, the heat transfer label assembly may include a release layer that facilitates separation of the heat transfer label from the carrier when the heat transfer label is applied to a container. The heat transfer label may include one or more components that comprise a thermoset formed from a curable composition, for example, an energy curable composition.

In yet another aspect, this disclosure is directed generally to a method of decorating a container with a flexible and extensible heat transfer label and a container decorated with a flexible and extensible heat transfer label.

Other features, aspects, and embodiments will be apparent from the following description and accompanying figures.

### BRIEF DESCRIPTION OF THE DRAWINGS

The description refers to the accompanying drawings in which like reference characters refer to like parts throughout the several views, and in which:

FIG. 1A is a schematic cross-sectional view of an exemplary heat transfer label assembly, including a heat transfer label;

FIG. 1B is a schematic cross-sectional view of another exemplary heat transfer label assembly, including a heat transfer label; and

FIG. 1C is a schematic perspective view of a container decorated with the heat transfer label of FIG. 1A or FIG. 1B; and

FIG. 2 is a schematic flowchart illustrating an exemplary apparatus or process 200 for forming the exemplary heat transfer label assembly of FIG. 1B.

### DESCRIPTION

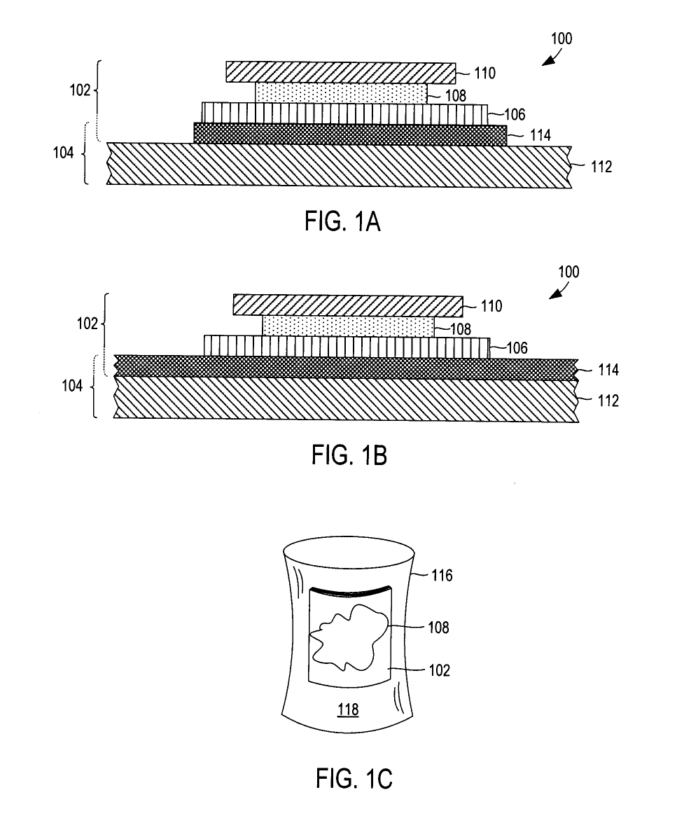

FIGS. 1A and 1B schematically illustrate variations of an exemplary heat transfer label assembly 100, with the relative widths of the various layers generally indicating the relative area of each layer in the structure. It will be understood that the relative thicknesses of the various layers may be altered or exaggerated for purposes of illustration, and that such thicknesses are not indicative of actual or relative thicknesses of actual structures. It will also be understood that, while one specific structure or assembly 100 is illustrated schematically in FIGS. 1A and 1B, each heat transfer label assembly may vary for each application. Layers may be added or omitted as needed. Other modifications are contemplated.

In the exemplary embodiments shown in FIGS. 1A and 1B, the heat transfer label assembly 100 generally comprises a plurality of layers that define a heat transfer label portion 102 (or simply heat transfer label or label) and a releasable support portion (or releasable carrier) 104. Each layer of the heat transfer label assembly 100 is in a substantially facing, contacting relationship with the respective adjacent layer(s).

The heat transfer label 102 generally includes a protective coating or layer 106, one or more ink layers 108 (shown as a single ink layer or ink coating 108) configured to define one or more graphics and/or text (collectively “decoration”), and an adhesive coating or layer 110. The releasable support portion 104 generally includes a carrier or substrate 112 and a release layer 114.

The carrier 112 generally comprises a base material on which the remaining layers of the heat transfer label assembly 100 are supported. However, although some layers or components of the heat transfer label assembly are described as “overlying” or being “on” other layers or components, it will be appreciated that the heat transfer label assembly 100 may be inverted, such that different layers or components may be said to “overlie” or be “on” others. Accordingly, such terminology is provided merely for convenience of explanation and not limitation in any manner.

When the label 102 is joined to a container 116 (FIG. 1C), the adhesive 110 generally contacts (i.e., is directly adjacent to) the exterior surface 118 of the container 116. The protective coating 106 (and/or any residual release layer 114 material) defines an outermost layer for the label 102 on the container 116 that serves to protect the decoration/ink 108 from damage.

A plurality of labels 102 are typically indexed along the length of the carrier 112 so that a multitude of containers 116 can be decorated using an automated process. It will be noted that the FIGS. 1A and 1B illustrate only one of such labels 102.

To use the heat transfer label assembly 100 according to one exemplary method, the assembly 100 may be brought into contact with the surface 118 of the container 116 with the adhesive 110 facing the container 116. Heat and pressure may be applied to the assembly 100 using, for example, a heated platen. The release layer 114 softens and allows the protective coating 106, ink 108, and adhesive 110 to separate from the carrier 112, while the application of pressure transfers the protective coating 106, ink 108, and adhesive 110 to the container 116. Additionally, at least some of the release layer 114 may transfer to the container 116. Thus, the outermost layer of the transferred label 102 may comprise the protective coating 106 and/or some of the release layer 114. The substrate or carrier 112 may be discarded if desired. Alternatively, it is contemplated that the substrate or carrier 112 may be recycled or reused. In some cases, the decorated container may then be subjected to a flaming process to improve the clarity of the heat transfer label.

When the heat transfer label 102 is applied to the container 116, the heat transfer label may be stretched to improve contact, and therefore, adhesion, between the heat transfer label and the container. In some cases, the heat transfer label 102 may be stretched only slightly, for example, from about 1 to about 4%. In other cases, for example, where the container is tapered or contoured (e.g., where the container has compound curves), at least a portion of the heat transfer label 102 may need to be stretched (i.e., extended or elongated) at least about 5%, for example, from about 6% to about 20%, for example, from about 8% to about 15%, for example, about 10% (where the percent stretch or extensibility or elongation is measured at typical decorating temperatures, for example, from about 225° F. to about 410° F.). Accordingly, the heat transfer label 102 ideally should be able to stretch or extend the desired amount in at least one direction so that the heat transfer label can be applied to the container without substantially cracking, speckling, distorting, or creating any other substantial defect in the decoration on the decorated container (e.g., as viewed by a naked eye) that would generally render the decorated container unacceptable.

The protective coating 106 and/or ink 108 may comprise any suitable material that is capable of achieving the desired degree of flexibility and extensibility for a particular decorating (i.e., labeling) application. More particularly, at least a portion of the protective coating 106 and/or ink 108 ideally stretches (i.e., extends or elongates) at least about 5%, for example, from about 6% to about 20%, for example, from about 8% to about 15%, for example, about 10%, in at least one direction without substantially cracking, speckling, distorting, or forming any other substantial defect in the label 102 when the label is applied to the container.

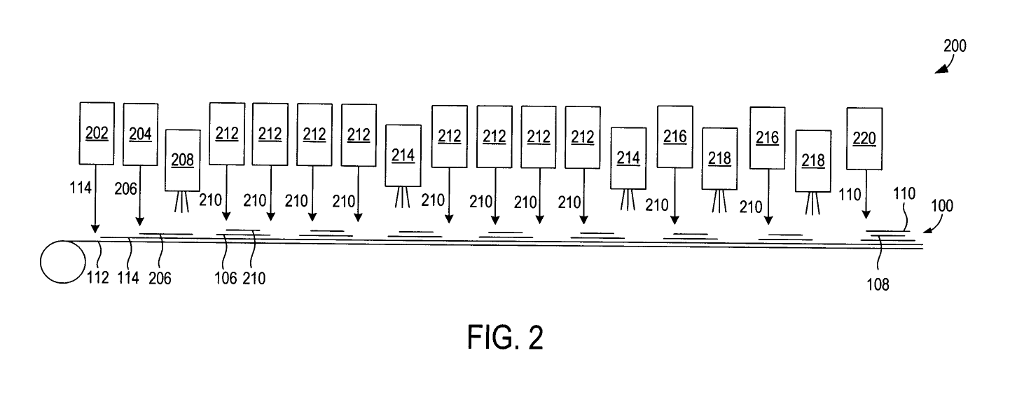

If desired, the protective coating 106 and/or ink 108 may be formed from a curable composition or system 206, 210 (FIG. 2), for example, an energy curable composition or system, so that the protective coating 106 and/or ink 108 may each independently comprise a thermoset (e.g., thermoset resin or thermoset polymer). Energy curable compositions are typically ultraviolet light (UV) curable or electron beam radiation (EB) curable. UV curable compositions typically include a reactive material that undergoes free radical polymerization or cationic polymerization. EB curable compositions typically include a reactive material that undergoes free radical polymerization. The reactive material may generally comprise a monomer, oligomer, or any other pre-polymer, a thermosetting material (e.g., a thermosetting resin), or any combination thereof. Thus, while oligomer-based compositions are described in detail herein hereafter, countless reactive materials may be used in any suitable combination to form the thermoset in accordance with the present invention.

The compositions used to form the protective coating 106 and/or ink 108 (e.g., compositions 206, 210 of FIG. 2) may vary for each decorating (i.e., labeling) application. While countless reactive materials may be used to form the thermoset, particularly suitable materials (e.g., energy curable or cross-linkable oligomers) may have an extensibility or elongation of at least about 50% when cured in a pure form (i.e., cured alone or as a neat material), as measured at typical decorating temperatures (e.g., from about 225° F. to about 410° F.). In some examples, suitable materials (e.g., oligomers) may have an extensibility or elongation of at least about 60%, at least about 70%, at least about 80%, at least about 90%, at least about 100%, at least about 110%, at least about 120%, at least about 130%, at least about 140%, or at least about 150% when cured alone. As a result, the resulting protective coating 106 and/or ink 108 can extend at least about 5% in at least one direction without forming defects. In sharp contrast, reactive materials (e.g., oligomers) used in conventional energy cured coatings typically have only up to about 20% extensibility when cured in a pure form (i.e., as a neat material). When these conventional energy cured reactive materials are formulated into an ink or coating, the resulting cured ink or coating has only about 1-3% extensibility (as measured at typical decorating temperatures, e.g., from about 225° F. to about 410° F.). As a result, conventional energy cured inks and coatings used in heat transfer labels are unable to stretch to conform to the shape of the container without cracking or forming some other defect.

Suitable oligomers used to form the protective coating 106 and/or ink 108 may include acrylate oligomers (e.g., urethane acrylate, polyester acrylate, and epoxy acrylate oligomers), epoxide oligomers, or any combination thereof. Acrylate oligomers typically form thermosets comprising acrylic resins or polymers, while epoxide oligomers typically form thermosets comprising epoxy resins. Some examples of oligomers that may be suitable for use in compositions for form the protective coating 106 and/or ink 108 are presented in Table 1, where HDODA is 1,6-hexanediol diacrylate, TRPGDA is tri(propylene glycol) diacrylate, IBOA is isobornyl acrylate, PEGDA is polyethylene glycol diacrylate, EOEOEA is 2-(2-ethoxyethoxy)ethyl acrylate, and TMPEOTA is trimethylolpropane ethoxylated triacrylate, and where the percent elongation and viscosity are measured at ambient temperature (data provided by supplier). However, countless other possible oligomers and/or other reactive materials may be used.

TABLE 1

| | | | Elong | Viscosity |
|---|---|---|---|---|
| Supplier | Product | Description | (%) | (cP) |
| Cognis | Photomer 6230 | aliphatic urethane acrylate | 50 | 50,000 |
| Cognis | RCC-12-891 | aliphatic urethane acrylate | 70 | 7,000 |
| Cognis | RCC-12-890 | aromatic urethane acrylate | 64 | 8,200 |
| Cytec | Ebecryl 230 | aliphatic urethane acrylate | 83 | 40,000 |
| Cytec | Ebecryl 244 | aliphatic urethane acrylate | 60 | 100,000 |
| Cytec | Ebecryl 264 | aliphatic urethane acrylate | 37 | 45,000 |
| Cytec | Ebecryl 270 | aliphatic urethane acrylate | 87 | 100,000 |
| Cytec | Ebecryl 284-N | aliphatic urethane acrylate | 58 | 60,000 |
| Cytec | Ebecryl 525 | polyester acrylate | 59 | 40,000 |
| Cytec | Ebecryl 745 | acrylated acrylic-23% HDODA/23% TRPGDA | 52 | 22,479 |
| Cytec | Ebecryl 4827 | aromatic urethane acrylate | 78 | 200,000 |
| Cytec | Ebecryl 4833 | aliphatic urethane acrylate | 120 | 100,000 |
| Cytec | Ebecryl 4883 | aliphatic urethane acrylate | 83 | 100,000 |
| Cytec | Ebecryl 6700 | aromatic urethane acrylate | 62 | 100,000 |
| Cytec | Ebecryl 8402 | aliphatic urethane acrylate | 90 | 20,000 |
| Cytec | Ebecryl 8411 | aliphatic urethane acrylate-20% IBOA | 320 | 149,500 |
| Cytec | Ebecryl 8804 | aliphatic urethane acrylate | 103 | 3,200,000 |
| Sartomer | CN131 | aromatic acrylate | 200 | 210 |
| Sartomer | CN704 | polyester acrylate | 227 | — |
| Sartomer | CN961K75 | aliphatic urethane acrylate-25% PEGDA | 70 | 72,000 |
| Sartomer | CN964H90 | aliphatic urethane acrylate-10% EOEOEA | 87 | 78,000 |
| Sartomer | CN964J75 | aliphatic urethane acrylate-25% IBOA | 63 | 30,000 |
| Sartomer | CN964K75 | aliphatic urethane acrylate-25% PEGDA | 67 | 21,000 |
| Sartomer | CN965H90 | aliphatic urethane acrylate-10% EOEOEA | 85 | 46,000 |
| Sartomer | CN965J75 | aliphatic urethane acrylate-25% IBOA | 82 | 20,000 |
| Sartomer | CN965K75 | aliphatic urethane acrylate-25% PEGDA | 54 | 17,000 |
| Sartomer | CN966E75 | aliphatic urethane acrylate-25% TMPEOTA | 68 | 73,000 |
| Sartomer | CN966J75 | aliphatic urethane acrylate-25% IBOA | 346 | 58,000 |
| Sartomer | CN966K75 | aliphatic urethane acrylate-25% PEGDA | 74 | 48,000 |
| Sartomer | CN973J75 | aromatic urethane acrylate-25% IBOA | 211 | 34,000 |
| Sartomer | CN981 | aliphatic urethane acrylate | 81 | — |
| Sartomer | CN996 | aliphatic urethane acrylate | 137 | — |
| Sartomer | CN2285 | acrylic oligomer | 121 | 350 |
| Sartomer | CN2402 | metallic acrylate | 336 | 240 |
| Sartomer | CN3100 | hydroxyl functional acrylate (details unknown) | 150 | 300 |
| Sartomer | CN3105 | hydroxyl functional acrylate (details unknown) | 170 | 370 |
| Sartomer | CN3211 | aliphatic urethane acrylate | 136 | 27,500 |
| Sartomer | CN9021 | acrylic ester acrylate | 1100 | 32,000 |
| Sartomer | CN9782 | aromatic urethane acrylate | 365 | — |
| Sartomer | CN9893 | aliphatic urethane acrylate | 160 | — |

If desired, the compositions used to form the protective coating 106 and/or ink 108 (e.g., compositions 206, 210 of FIG. 2) may also include a viscosity modifier. The viscosity modifier may be used to impart additional flexibility and/or extensibility to the cured protective coating 106 and/or ink 108, as needed for a particular labeling application.

The viscosity modifier may comprise any suitable material, and in one example, the viscosity modifier may comprise a monomer, for example, an energy curable monomer. Suitable energy curable monomers may include, for example, acrylate monomers, diacrylate monomers, triacrylate monomers, or any combination thereof. Some examples of such monomers are presented in Table 2, where β-CEA is β-carboxyethyl acrylate, DPGDA is dipropylene glycol diacrylate, HDODA is 1,6-hexanediol diacrylate, IBOA is isobornyl acrylate, NPG(PO)2DA is neopentyl glycol diacrylate, ODA is octyl/decyl acrylate, PETIA is pentaerythritol tri/tetra acrylate, TMPEOTA is trimethylolpropane ethoxylated triacrylate, TRPGDA is tripropylene glycol diacrylate, and where the percent elongation and viscosity are measured at ambient temperature (data provided by supplier). However, countless other possible monomers (and combinations thereof) and/or other viscosity modifiers may be used.

TABLE 2

| | | | Elong. | Viscosity |
|---|---|---|---|---|
| Supplier | Product | Description | (%) | (cP) |
| Cognis | Photomer 4028 | bisphenol A ethoxylate diacrylate | 30 | 1100 |
| Cognis | Photomer 4072 | trimethyolpropane propoxylate triacrylate | 33 | 100 |
| Cognis | Photomer 4127 | propoxylated neopentylglycol diacrylate | 18 | 20 |
| Cognis | Photomer 4160 | ethoxylated neopentylglycol diacrylate | 10 | 20 |
| Cytec | β-CEA | β-carboxyethyl acrylate | — | 75 |
| Cytec | DPGDA | dipropyleneglycol diacrylate | — | 10 |
| Cytec | HDODA | 1,6-hexanediol diacrylate | — | 6 |
| Cytec | IBOA | isobornyl acrylate | — | 5 |
| Cytec | NPG(PO)2DA | propoxylated neopentylglycol diacrylate | 19 | 15 |
| Cytec | ODA | octyl/decyl acrylate | — | 3 |
| Cytec | OTA-480 | propoxylated glycerol triacrylate | 15 | 90 |
| Cytec | PETIA | pentaerythritol tri/tetra acrylate | — | 1100 |
| Cytec | TMPEOTA | trimethyolpropane triacrylate | — | 60 |
| Cytec | TRPGDA | tripropyleneglycol diacrylate | 11 | 15 |
| Cytec | Ebecryl 150 | bisphenol A ethoxylate diacrylate | 9 | 1400 |
| Cytec | Ebecryl 1039 | urethane acrylate | 15 | 40 |
| Sartomer | CD590 | aromatic acrylate | 240 | 180 |
| Sartomer | SR-444 | pentaerythritol triacrylate | — | 520 |
| Sartomer | SR-9020 | glycerol triacrylate | 11 | 100 |

In another example, the viscosity modifier may comprise a thermoplastic resin, for example, a non-curable thermoplastic resin. While not wishing to be bound by theory, it is believed that the thermoplastic resin lowers the crosslink density of the thermoset (e.g., by hindering some of the crosslinking of the oligomer or other reactive material, for example, by consuming reaction sites) and/or acts as a plasticizer to make the cured protective coating 106 and/or ink 108 more flexible. Examples of thermoplastic resins that may be suitable for use as a viscosity modifier in a composition used to form the protective coating 106 and/or ink 108 include, but are not limited to, hydroxy terminated epoxidized 1,3 polybutadiene (e.g., Cytec BD605E), liquid polybutadiene polymer (e.g., Cytec Ricon 153), epoxidized soybean and linseed fatty acid esters (e.g., Arkema Vikoflex 7010, 7040, 7080, 9010, 9040, 9080), epoxy plasticizers (e.g., Chemtura Drapex), or any combination thereof. However, other possibilities are contemplated.

It is also contemplated that in some embodiments, a combination of one or more monomers and/or one or more thermoplastic resins may be used in the compositions used to form the protective coating 106 and/or ink 108.

The relative amounts of the oligomer and viscosity modifier (e.g., monomer and/or thermoplastic resin) in the compositions used to form the protective coating 106 and/or ink 108 may vary, for example, depending on the properties of the various components used in a particular composition and the type of process used to apply the composition. For example, compositions used with lithographic (e.g., offset) printing typically need to have a viscosity of at least about 5,000 cP, and in some examples, may have a viscosity of at least about 8000 cP, at least about 10,000 cP, or at least about 12,000 cP. In sharp contrast, compositions used with flexographic printing typically need to have a viscosity of at less than about 2,000 cP, and in some examples, may have a viscosity of less than about 1,000 cP or less than about 500 cP. Thus, for a given mixture of oligomer and other components (e.g., pigment, ink, photoinitiator, etc., discussed below), a greater amount of viscosity modifier may be needed for flexographic printing (to reduce the viscosity), while less viscosity modifier may be needed for lithographic (e.g., offset) printing.

By way of example, and not limitation, some compositions used to form the protective coating 106 and/or ink 108 may include from about 15 to about 65 wt % oligomer and from about 20 to about 50 wt % viscosity modifier (e.g., monomer and/or thermoplastic resin), for example, from about 18 to about 55 wt % oligomer and from about 25 to about 45 wt % viscosity modifier, or from about 20 to about 50 wt % oligomer and from about 28 to about 39 wt % viscosity modifier.

The ratio of oligomer to viscosity modifier (e.g., monomer and/or thermoplastic resin) may be from about 0.25 to about 2, for example, from about 0.4 to about 1.75, for example, from about 0.6 to about 1.5, for example, from about 0.7 to about 1.25, for example, or from about 0.73 to about 1.23. In some specific examples, the ratio of oligomer to viscosity modifier may be about 0.7, about 0.8, about 0.9, about 1.0, or about 1.2. However, countless other compositions may be used to achieve the desired properties of the composition(s) and resulting protective coating 106 and/or ink 108.

The compositions used to form the protective coating 106 and/or ink 108 may each independently include one or more of various additional components, for example, colorants (e.g., pigments or inks), photoinitiators, inhibitors, dispersants, lubricants (e.g., wax), anti-misting agents (e.g., silica and microtalc), flow agents, wetting agents, or any combination thereof. While such additional components are typically non-reactive, some photoinitiators may be reactive. Thus, the total amount of reactive and non-reactive components in each composition may vary. By way of example, and not limitation, some compositions may include from about 50 to about 95 wt % reactive components, from about 55 to about 90 wt % reactive components, from about 60 to about 85 wt % reactive components, or from about 65 to about 75 wt % reactive components. However, countless other amounts and ranges are contemplated. Thus, the resulting protective coating 106 and/or ink 108 may include the thermoset, viscosity modifier (e.g., thermoplastic material, where used), and any of a variety of other components.

As stated above, the resulting protective coating 106 and/or ink 108 can stretch (i.e., extend or elongate) at least about 5%, for example, from about 6% to about 20%, for example, from about 8% to about 15%, for example, about 10% in at least one direction without substantially cracking, speckling, distorting, or forming any other substantial defect. Thus, the heat transfer label can be applied to a highly contoured container without substantial defects. In sharp contrast, presently commercially available UV curable coatings and inks typically stretch only about 1-3%, which generally limit their use in heat transfer labels to straight-walled containers.

It will be appreciated that while such coating and ink compositions and resulting films are described herein for use in heat transfer labels, such coating and ink compositions may find use in other applications.

Various materials may be used to form the remaining layers of the heat transfer label assembly 100, and each layer may have various basis weights or coat weights, depending on the particular application.

The substrate or carrier 112 may generally comprise a flexible material, for example, paper. The paper may include a clay coating on one or both sides. The paper may have a basis weight of from about 5 to about 75 lb/ream (i.e., lb/3000 sq. ft.), for example, about 10 to about 50 lb/ream, for example, from about 20 to about 30 lb/ream. Other ranges and basis weights are contemplated. Alternatively, the carrier 112 may comprise a polymer film, for example, a polyolefin film or polyethylene terephthalate film having a thickness of from about 1 to about 3 mil, for example, 2 mil. One example of a polyethylene terephthalate film that may be suitable is Polyester HS, 142 gauge S1S PET, commercially available from Griffin Paper and Films (Holliston, Mass.). However, other suitable carriers may be used.

The release layer 114 may generally comprise any suitable material that facilitates the release of the heat transfer label from the carrier 112. In one example, the release layer 114 may comprise a wax, for example, up to 100% wax, which may be typically applied in an amount of about 6 lb/ream. In another example, the release layer 114 may comprise a polymer (or polymeric material) and a wax having a coat weight of from about 0.5 to about 5 lb/ream (on a dry basis), for example, from about 1 to about 3 lb/ream, for example, about 2.5 lb/ream. However, other ranges and amounts are contemplated. Any suitable polymer and/or wax may be used. For example, the polymer may comprise a polyolefin or an olefin copolymer, for example, an undecanoic acid copolymer (e.g., X-6112 polymer from Baker Hughes, Barnsdall, Okla.). The wax may comprise carnauba wax, and more particularly, may comprise micronized carnauba wax (e.g., MICROKLEAR 418 Micronized Carnauba Wax, Micro Powders, Inc., Tarrytown, N.Y.). The polymer and wax may be present in any suitable relative amounts. For example, the polymer and wax may be present in a ratio of from about 3:1 to about 1:3 by weight, for example, from about 2.5:1 to about 1.5:1, for example, about 2:1. However, numerous other components and relative amounts of such components may be used.

The adhesive 110 may generally comprise a thermally activated adhesive that is capable of adhering the remainder of the heat transfer label to the surface 118 of the container 116. Additionally, the adhesive 110 ideally is capable of achieving the desired degree of flexibility and extensibility needed for a particular decorating (i.e., labeling) application. More particularly, the adhesive 110 may ideally stretch or extend at least about 5%, for example, from about 6% to about 20%, for example, from about 8% to about 15%, for example, about 10%, in at least one direction without substantially cracking, speckling, distorting, or forming any other substantial defect in the label 102 when the label is applied to the container.

The type of adhesive used may vary depending on the type of container being used. For example, when the container is polyethylene, one suitable adhesive may be a polyamide adhesive. Alternatively, when the container is glass, one suitable adhesive may be a polyester adhesive. The adhesive may be water-based, solvent-based, or energy curable. One example of an adhesive that may be suitable is 7MXWF3278 water-based adhesive available from Color Resolutions International (Fairfield, Ohio). Another example of an adhesive that may be suitable is RAD-BOND HS-30 RAVG00243 UV curable adhesive available from Actega Wit. However, numerous other possibilities are contemplated.

The amount of adhesive may vary for each application. The adhesive may generally be applied in an amount of from about 0.5 to about 3 lb/ream (dry), for example, from about 1 to about 1.5 lb/ream. As shown in FIG. 1A, the adhesive 110 may generally be applied in register with the ink 108 to be transferred to the container 116 and also may extend beyond the peripheral margin of the ink 108 to ensure complete transfer of the ink 108 to the container 118.

Any suitable method may be used to make a heat transfer label assembly 100 according to the disclosure, or numerous other heat transfer label assemblies encompassed hereby. Further, different printing techniques may be used to achieve the desired print quality and coat weight while minimizing cost.

For example, in one exemplary apparatus or process 200 schematically illustrated in FIG. 2, the substrate or carrier 112 may be unwound from a roll. At a first printing station 202, for example, a gravure printing station including a gravure print unit or gravure printer, the release layer 114 may be deposited onto the carrier 112. The release layer 114 may be applied to the carrier 112 in approximately the same shape/area as the label decoration (i.e., the ink 108) (FIG. 1A), or may comprise a substantially continuous layer (i.e., a flood coat) (FIG. 1B, FIG. 2). In an alternate process (not shown), the carrier 112 may be provided with the release layer 114 pre-coated onto one side of the carrier 112 (i.e., the release portion 104 may be pre-formed):

In some embodiments (e.g., where the release layer 114 substantially comprises wax), the wax may be applied as a molten wax.

In other embodiments (e.g., where the release layer 114 comprises polymer and a wax), the release layer 114 may be applied to the carrier 112 at ambient temperature as a relatively low solids composition, for example, from about 20% to about 25% solids (wt %) (polymer plus wax), and dried. In one particular example, the release layer composition may include about 22% solids. Other solids levels are contemplated.

The release layer composition may generally include the polymer and wax solids and a diluent, which also may serve as a drying agent. If desired, the release layer composition may include other components, for example, solvents and/or other additives (e.g., optical brighteners, processing aids, printing aids, and so on).

In one example, the release layer composition may include (where all parts are by weight):
about 60 parts solvent;
about 22 parts solids; and
about 18 parts diluent/drying agent.

In another example, the release layer composition may include the polymer and wax solids, a diluent/drying agent, a solvent, and optionally, an optical brightener. More particularly, the release layer composition may include (where all parts are by weight):
about 59.9 parts solvent;
about 14.6 parts polymer or polymeric material;
about 7.4 parts wax;
about 18.0 parts diluent/drying agent; and
about 0.1 parts optical brightener.

More particularly still, another exemplary release layer composition may include (where all parts are by weight):
about 59.9 parts toluene (solvent);
about 14.6 parts olefin copolymer;
about 7.4 parts micronized 100% carnauba wax;
about 18.0 parts ethyl alcohol (drying agent); and
about 0.1 parts D-298 columbia blue optical brightener.

While some exemplary release layer compositions are provided, it will be appreciated that countless other compositions are contemplated by the disclosure. Other solvents, release layer solids, diluents/drying agents, and other components may be used. Additionally, the relative amounts of each component may vary for each application. Further, other types of print units or printers may be used to apply the release layer, for example, a lithographic, flexographic, or digital print unit or printer.

A protective coating composition 206 (e.g., such as the energy curable protective coating compositions described above) may be deposited on the release layer 114 at a second printing station 204, which may include a lithographic print unit or printer (e.g., an offset print unit or printer), a flexographic print unit or printer, or any other suitable print unit or printer (e.g., gravure, digital, and so on). The protective coating composition 206 may then be cured at a first curing unit 208, which may be provided with one or more UV lamps (e.g., 200-600W per linear inch bulbs) or other suitable energy source, where sufficient exposure to the UV light cures the coating 206 and forms the thermoset. The resulting protective coating 106 may have a basis weight of from about 1 to about 1.5 lb/ream. However, other suitable weights and ranges thereof may be used. Notably, the resulting protective coating 106 is able to stretch (i.e., extend or elongate) at least about 5%, for example, from about 6% to about 20%, for example, from about 8% to about 15%, for example, about 10%, in at least one direction without substantially cracking, speckling, distorting, or creating any other substantial defect in the label decoration (i.e., ink 108 configured as graphics and/or text). In other embodiments where a non-energy curable protective composition is used, curing unit 208 may be omitted.

One or more ink compositions (all of which are labeled 210 in FIG. 2) (e.g., such as the energy curable ink compositions described above) may be deposited on the cured protective coating 106 at a plurality of printing stations (e.g., third, fourth, fifth, sixth, seventh, eighth, ninth, and tenth printing stations, all of which are labeled 212 in FIG. 2), each of which independently may include a lithographic print unit or printer (e.g., an offset print unit or printer), a flexographic print unit or printer, or any other suitable print unit or printer (e.g., gravure, digital, and so on). The thickness of each printed ink composition layer may vary. Where lithographic/offset printing is used, each layer may be about 1-2 microns thick; where flexographic printing is used, each layer may be about 2 microns thick. Thus, it will be appreciated that the total thickness of the ink 108 depends on the type of printing process used and the number of layers that are printed. It will be also appreciated that although eight print units are shown in the illustrated embodiment, other numbers of print units may be used.

The ink composition 210 may be cured at ink curing units 214 which may be provided with one or more UV lamps (e.g., 200-600W per linear inch bulbs) or other suitable energy source, where sufficient exposure to the UV light cures the ink composition 210 and forms the thermoset. In this example, a first curing unit 214 is located between the fourth and fifth ink printing stations 212 and a second curing unit 214 is located after the eighth printing station 212. However, other numbers of curing units 214 and configurations thereof are contemplated. Notably, the resulting ink (i.e., decoration) is able to stretch (i.e., extend or elongate) at least about 5%, for example, from about 6% to about 20%, for example, from about 8% to about 15%, for example, about 10%, in at least one direction without substantially cracking, speckling, distorting, or forming any other substantial defect. In other embodiments where a non-energy curable ink composition 210 is used, one or more of curing units 214 may be omitted.

If desired (e.g., where the heat transfer label is to be applied to a colored container), one or more layers of white ink composition 210 may be deposited onto the cured colored ink at eleventh and twelfth printing stations 216, each of which independently may include a lithographic print unit or printer (e.g., an offset print unit or printer), a flexographic print unit or printer, or any other suitable print unit or printer (e.g., gravure, digital, and so on). When the white ink composition is energy curable (e.g., such as the energy curable ink compositions described above), the ink composition 210 may be cured at curing units 218 which may be similar to those described above. While two white ink print units 216 are shown in the illustrated embodiment, other numbers of print units may be used. Such units 216, 218 also may be omitted in some embodiments.

The adhesive 110 may then be deposited on the cured ink 108 at a thirteenth printing station 220 which may include a lithographic print unit or printer (e.g., an offset print unit or printer) or a flexographic print unit or printer (or, in other embodiments, a gravure print unit or printer or a digital print unit or printer), and subsequently dried. The resulting heat transfer label assembly 100 may then be wound into a roll (not shown) if desired.

The heat transfer label assembly 100 may be used to decorate any suitable container, for example, a conventional container formed from polyethylene, polypropylene, high density polyethylene, polyethylene terephthalate, acrylonitrile, metal, glass, Barex, or any other suitable material or combination of materials. According to one exemplary method, the assembly 100 may be unwound from a roll, and the exterior side of the carrier 112 (i.e., the side of the carrier 112 distal from the release layer 114) may be brought into contact with a preheat plate to soften the release layer 114. The preheat plate may be heated to a temperature of, for example, from about 135° F. to about 220° F., for example, from 135° F. to about 220° F., for example, from about 150° F. to about 160° F., or from about 180° F. to about 220° F., depending on the particular materials used in the assembly 100). A heated platen may then urge the assembly 100 against the container 116 so that the platen is in contact with the exterior side of the carrier 112 and the adhesive 110 is in contact with the container 116. The platen may be heated to a temperature of, for example, from about 225° F. to about 410° F., for example, from about 225° F. to about 300° F., for example, from about 250° F. to 260° F., or from about 350° F. to about 410° F., depending on the particular materials used in the assembly 100). The heat from the platen causes the softened release layer 114 to flow so that the protective coating 106, ink 108, and adhesive 110 (i.e., the label 102) (and, optionally, some of the release layer 114) collectively transfer to the container 116 as the carrier 112 and residual release layer 114 are pulled away from the decorated container 116.

As the label 102 is urged against the container 116, all or a portion of the label 102 may be stretched to ensure close conformance to the shape of the container 116. For example, the entire label may be stretched 1-2% to generally maintain control over the label as it is transferred, and one or more portions of the label may be stretched additionally (e.g., at least about 5%) to accommodate shaped (e.g., tapered or contoured) containers. As stated previously, the heat transfer label is able to flex and extend to conform to the contours of variously shaped containers without forming substantial defects in the label decoration. Notably, prior to the present invention, energy curable compositions could not be used effectively because they lacked the flexibility and extensibility needed to accommodate the contours of the container without forming defects in the label. However, in sharp contrast to commercially available energy curable coating and ink compositions which typically extend only about 1-2% before forming substantial defects, the protective coating and ink compositions described herein form flexible films that can extend at least about 5% without forming substantial defects. As a result, the heat transfer label manufacturer is afforded greater process flexibility, for example, to use UV offset printing, which does not have the problems associated with solvent based processes.

It will be appreciated that countless processes and combinations thereof are contemplated by this disclosure, and the precise process may depend on numerous factors including, but not limited to, the particular requirements for the heat transfer label and/or decorating application. By considering the desired attributes for each layer of the heat transfer label assembly, the various stations or stages of the process may be tailored to provide the required level of print quality at the most economically feasible level, with the most flexibility. Notably, a system that uses at least some UV offset printing and/or flexographic printing may be significantly more cost effective than a system that uses only gravure printing. Further, in a system in which UV offset printing is used (for example, with the UV curable inks and protective coating of the present disclosure or any other suitable materials), the print quality may be equivalent to, or in some cases, superior to, to that of gravure printing, at a reduced cost, with greater flexibility. Thus, the various aspects of the present invention, used alone or in combination, may provide significant advantages over conventional technology that uses gravure printing exclusively.

The present invention may be understood further in view of the following Examples, which are not intended to be limiting in any manner.

### EXAMPLE 1

A heat transfer label assembly was prepared using offset printing to apply the UV curable protective coating and UV curable ink compositions described below. The heat transfer label was successfully applied to a container with portions of the label being stretched at least about 12% with no observable defects.

Protective coating composition (parts by weight):
about 35 parts CN2285 monomer (Sartomer)
about 44 parts EB 8804 acrylated polyurethane oligomer (Cytec)
about 8 parts R972 silica (Evonic)
about 3 parts 1731 microtalc (MPSI)
about 8 parts PI K7 photoinitiator compound (IdeOn LLC)
about 1 part Slipayd 1606PE polyethylene wax (Shamrock)
about 1 part Genorad 16 inhibitor compound (Rahn)

Yellow ink composition (parts by weight):
about 35 parts CN2285 monomer (Sartomer)
about 36 parts EB 8804 acrylated polyurethane oligomer (Cytec)
about 15.7 parts yellow 174 pigment (Sun Chemical)
about 0.3 parts red 2 pigment (Sun Chemical)
about 2 parts R972 silica (Evonic)
about 3.5 parts 1731 microtalc (MPSI)
about 6 parts PI K6 photoinitiator compound (IdeOn LLC)
about 1.5 parts Genorad 16 inhibitor compound (Rahn)

Magenta ink composition (parts by weight):
about 34.5 parts CN2285 monomer (Sartomer)
about 31 parts EB 8804 acrylated polyurethane oligomer (Cytec)
about 1.5 parts BYK 9077 dispersant (Altana)
about 10 parts red 2 pigment (Sun Chemical)
about 8 parts red 57:1 pigment (Sun Chemical)
about 2 parts R972 silica (Evonic)
about 3.5 parts 1731 microtalc (MPSI)
about 8 parts PI K6 photoinitiator compound (IdeOn LLC)
about 1.5 parts Genorad 16 inhibitor compound (Rahn)

Cyan ink composition (parts by weight):
about 34.5 parts CN2285 monomer (Sartomer)
about 34 parts EB 8804 acrylated polyurethane oligomer (Cytec)
about 1 part BYK 168 dispersant (Altana)
about 16 parts blue 15:4 pigment (Sun Chemical)
about 2 parts R972 silica (Evonic)
about 3.5 parts 1731 microtalc (MPSI)
about 8 parts PI K6 photoinitiator compound (IdeOn LLC)
about 1 parts Genorad 16 inhibitor compound (Rahn)

Black ink composition (parts by weight):
about 35 parts CN2285 monomer (Sartomer)
about 28 parts EB 8804 acrylated polyurethane oligomer (Cytec)
about 1.5 parts BYK 9077 dispersant (Altana)
about 16 parts black 7 pigment (Sun Chemical)
about 3.5 parts blue 61 pigment (Flint)
about 2 parts R972 silica (Evonic)
about 3.5 parts 1731 microtalc (MPSI)
about 9 parts PI K6 photoinitiator compound (IdeOn LLC)
about 1.5 parts Genorad 16 inhibitor compound (Rahn)

### EXAMPLE 2

A heat transfer label assembly was prepared using offset printing to apply the UV curable ink compositions described below. The heat transfer label was successfully applied to a container with portions of the label being stretched at least about 12% with no observable defects.

Yellow ink composition (parts by weight):
about 39 parts CN2285 monomer (Sartomer)
about 32 parts EB 8804 acrylated polyurethane oligomer (Cytec)
about 1 part BYK 167 dispersant (Altana)
about 16 parts yellow 174 pigment (Sun Chemical)
about 2 parts R972 silica (Evonic)
about 3.5 parts 1731 microtalc (MPSI)
about 6 parts PI K6 photoinitiator compound (IdeOn LLC)
about 0.5 parts Genorad 16 inhibitor compound (Rahn)

Magenta ink composition (parts by weight):
about 36.5 parts CN2285 monomer (Sartomer)
about 31.5 parts EB 8804 acrylated polyurethane oligomer (Cytec)
about 1.5 parts BYK 168 dispersant (Altana)
about 17 parts red 57:1 pigment (Sun Chemical)
about 1.5 parts R972 silica (Evonic)
about 3 parts 1731 microtalc (MPSI)
about 8 parts PI K6 photoinitiator compound (IdeOn LLC)
about 1.5 parts Genorad 16 inhibitor compound (Rahn)

Cyan ink composition (parts by weight):
about 34.5 parts CN2285 monomer (Sartomer)
about 34 parts EB 8804 acrylated polyurethane oligomer (Cytec)
about 1 part BYK 168 dispersant (Altana)
about 16 parts blue 15:4 pigment (Sun Chemical)
about 2 parts R972 silica (Evonic)
about 3.5 parts 1731 microtalc (MPSI)
about 8 parts PI K6 photoinitiator compound (IdeOn LLC)
about 1 part Genorad 16 inhibitor compound (Rahn)

Black ink composition (parts by weight):
about 33.5 parts CN2285 monomer (Sartomer)
about 32 parts EB 8804 acrylated polyurethane oligomer (Cytec)
about 2 parts BYK 168 dispersant (Altana)
about 16 parts black 7 pigment (Sun Chemical)
about 3.5 parts blue 61 pigment (Flint)
about 1 part R972 silica (Evonic)
about 2 parts 1731 microtalc (MPSI)
about 9 parts PI K6 photoinitiator compound (IdeOn LLC)
about 1.5 parts Genorad 16 inhibitor compound (Rahn)

White ink composition (parts by weight):
about 28 parts CN2285 monomer (Sartomer)
about 20.5 parts EB 8804 acrylated polyurethane oligomer (Cytec)
about 2 parts BYK 111 dispersant (Altana)
about 1 part Slipayd 1606PE polyethylene wax (Shamrock)
about 40 parts TiO2
about 8 parts PI K6 photoinitiator compound (IdeOn LLC)
about 0.5 parts Genorad 16 inhibitor compound (Rahn)

Green ink composition (parts by weight):
about 33 parts CN2285 monomer (Sartomer)
about 33 parts EB 8804 acrylated polyurethane oligomer (Cytec)
about 1 part BYK 111 dispersant (Altana)
about 20 parts green 7 pigment
about 1 part R972 silica (Evonic)
about 3 parts 1731 microtalc (MPSI)
about 8 parts PI K6 photoinitiator compound (IdeOn LLC)
about 1 part Genorad 16 inhibitor compound (Rahn)

Magenta ink composition (parts by weight):
about 38.5 parts CN2285 monomer (Sartomer)
about 32 parts EB 8804 acrylated polyurethane oligomer (Cytec)
about 2 parts BYK 111 dispersant (Altana)
about 13 parts V23 Carbazole Violet pigment
about 2 parts R972 silica (Evonic)
about 3.5 parts 1731 microtalc (MPSI)
about 8 parts PI K6 photoinitiator compound (IdeOn LLC)
about 1 part Genorad 16 inhibitor compound (Rahn)

### EXAMPLE 3

A heat transfer label assembly was prepared using flexographic printing to apply the UV curable protective coating and UV curable ink composition described below. The heat transfer label was successfully applied to a container with portions of the label being stretched at least about 10% with no observable defects.

Protective coating composition (parts by weight):
about 25 parts CN131 monomer (Sartomer)
about 15.5 parts IBOA monomer (Cytec)
about 49.85 parts CN3100 oligomer (Sartomer)
about 4 parts benzophenone (Cytec)
about 2 parts methyldiethanolamoine (Cytec)
about 2 parts KIP-100F photo-initiator (Lamberti)
about 1.5 parts Irgacure 1700 photo-initiator (CIBA)
about 0.15 parts 4-methoxyphenol inhibitor (Eastman)

White ink composition (parts by weight):
about 17.5 parts CN131 monomer (Sartomer)
about 11.05 parts IBOA monomer (Cytec)
about 35.1 parts CN3100 oligomer (Sartomer)
about 30 parts CR-828 titanium dioxide pigment (Tronox)
about 1.4 parts Solsperse 32000 dispersant (Lubrizol)
about 2 parts benzophenone (Cytec)
about 1 part methyldiethanolamoine (Cytec)
about 1 part KIP-100F photo-initiator (Lamberti)
about 0.75 parts Irgacure 1700 photo-initiator (CIBA)
about 0.10 parts 4-methoxyphenol inhibitor (Eastman)

Although certain embodiments of this invention have been described with a certain degree of particularity, those skilled in the art could make numerous alterations without departing from the spirit or scope of this invention. Any directional references (e.g., upper, lower, upward, downward, left, right, leftward, rightward, top, bottom, above, below, vertical, horizontal, clockwise, and counterclockwise) are used only for identification purposes to aid the reader's understanding of various embodiments, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific examples or aspects, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is not intended nor is to be construed to limit the present invention or otherwise to exclude any such other embodiments, adaptations, variations, modifications, and equivalent arrangements of the present invention.

What is claimed is:

1. A heat transfer label assembly, comprising:
a label portion including an energy cured ink, the label portion being releasably supported on a carrier, wherein the label portion is extensible at least about 5% in at least one direction without creating substantial defects in the label portion.

2. The heat transfer label assembly of claim 1, wherein the energy cured ink comprises a thermoset.

3. The heat transfer label assembly of claim 2, wherein the thermoset comprises an acrylic resin.

4. The heat transfer label assembly of claim 2, wherein the energy cured ink further comprises a thermoplastic resin.

5. The heat transfer label assembly of claim 4, wherein the thermoplastic resin is selected from the group consisting of hydroxy terminated epoxidized 1,3 polybutadiene, liquid polybutadiene polymer, epoxidized soybean and linseed fatty acid esters, epoxy plasticizers, and any combination thereof.

6. The heat transfer label assembly of claim 1, wherein the label portion further includes an energy cured protective coating.

7. The heat transfer label assembly of claim 6, wherein the energy cured protective coating comprises a thermoset.

8. The heat transfer label assembly of claim 7, wherein the thermoset comprises an acrylic resin.

9. The heat transfer label assembly of claim 6, wherein the energy cured protective coating further comprises a thermoplastic resin.

10. The heat transfer label assembly of claim 9, wherein the thermoplastic resin is selected from the group consisting of hydroxy terminated epoxidized 1,3 polybutadiene, liquid polybutadiene polymer, epoxidized soybean and linseed fatty acid esters, epoxy plasticizers, and any combination thereof.

11. The heat transfer label assembly of claim 1, wherein the label portion is extensible from about 6% to about 20% in at least one direction without creating substantial defects in the label portion.

12. The heat transfer label assembly of claim 1, wherein the label portion is extensible from about 8% to about 15% in at least one direction without creating substantial defects in the label portion.

13. The heat transfer label assembly of claim 1, wherein the energy cured ink is cured by ultraviolet light.

14. The heat transfer label assembly of claim 1, wherein the energy cured ink is cured by electron beam radiation.

15. A heat transfer label assembly, comprising:
a heat transfer label portion including at least one of a cured protective coating and a cured ink, the at least one of the cured protective coating and the cured ink comprising a thermoset; and
a release portion releasbly joined to the heat transfer label portion,
wherein the at least one of the cured protective coating and the cured ink is extensible at least about 5% in at least one direction without forming substantial defects in the heat transfer label portion.

16. The heat transfer label assembly of claim 15, wherein the thermoset of the at least one of the cured protective coating and the cured ink comprises an acrylic resin.

17. The heat transfer label assembly of claim 15, wherein the at least one of the cured protective coating and the cured ink further comprises a thermoplastic resin.

18. The heat transfer label assembly of claim 17, wherein the thermoplastic resin is selected from the group consisting of hydroxy terminated epoxidized 1,3 polybutadiene, liquid polybutadiene polymer, epoxidized soybean and linseed fatty acid esters, epoxy plasticizers, and any combination thereof.

19. The heat transfer label assembly of claim 15, wherein the heat transfer label portion is extensible from about 6% to about 20% in at least one direction without creating substantial defects in the heat transfer label portion.

20. The heat transfer label assembly of claim 15, wherein the heat transfer label portion is extensible from about 8% to about 15% in at least one direction without creating substantial defects in the heat transfer label portion.

21. The heat transfer label assembly of claim 15, wherein the at least one of the cured protective coating and the cured ink is energy cured.

22. A heat transfer label, comprising:
a protective coating;
a layer of adhesive; and
an ink disposed between the protective coating and the layer of adhesive, the ink being configured to define at least one of a graphic and text,
wherein
the protective coating and the ink each independently comprise a thermoset, and
the protective coating and ink are each extensible at least about 5% in at least one direction without creating substantial defects in the at least one of the graphic and text.

23. The heat transfer label of claim 22, wherein the thermoset of at least one of the protective coating and the ink comprises an acrylic resin.

24. The heat transfer label of claim 23, wherein at least one of the protective coating and the ink further comprises a thermoplastic resin.

25. The heat transfer label of claim 24, wherein the thermoplastic resin is selected from the group consisting of hydroxy terminated epoxidized 1,3 polybutadiene, liquid polybutadiene polymer, epoxidized soybean and linseed fatty acid esters, epoxy plasticizers, and any combination thereof.

26. The heat transfer label of claim 22, wherein the protective coating and ink are each extensible from about 6% to about 20% in at least one direction without creating substantial defects in the at least one of the graphic and text.

27. The heat transfer label of claim 22, wherein the protective coating and ink are each extensible from about 8% to about 15% in at least one direction without creating substantial defects in the at least one of the graphic and text.

28. The heat transfer label of claim 22, in combination with a container, wherein the label is mounted to the container.

29. A method of making a heat transfer label assembly, the method comprising:
depositing a protective coating composition onto a releasable carrier;
curing the protective coating composition to form a cured protective coating;
depositing an ink composition onto the cured protective coating;
curing the ink composition to form a cured ink; and
depositing an adhesive onto the cured ink,
wherein
the cured protective coating, cured ink, and adhesive define a label portion of the heat transfer label assembly, and
the cured protective coating and cured ink are extensible at least about 5% in at least one direction without creating substantial defects in the label portion.

30. A method of decorating a container, the method comprising:
contacting a heat transfer label with a container, the heat transfer label comprising
an adhesive layer for joining the heat transfer label to the container,
a protective coating, and
ink disposed between the adhesive layer and protective coating, the ink defining decoration for decorating the container,
wherein the protective coating and ink each independently comprise a thermoset; and
stretching the heat transfer label while contacting the heat transfer label with the container, so that at least a portion of the heat transfer label is stretched at least about 5% in at least one direction without creating substantial defects in the decoration.
